(19) United States
(12) Patent Application Publication
(10) Pub. No.: US 2025/0139509 A1
(43) Pub. Date: May 1, 2025

(54) ENHANCEMENT OF TRAINING NODE SELECTION FOR TRUSTWORTHY FEDERATED LEARNING

(71) Applicant: Nokia Technologies Oy, Espoo (FI)

(72) Inventors: Tejas SUBRAMANYA, Munich (DE); Prajwal KESHAVAMURTHY, Munich (DE)

(21) Appl. No.: 18/683,541

(22) PCT Filed: Sep. 22, 2021
(86) PCT No.: PCT/EP2021/076004

§ 371 Date: Feb. 14, 2024

(51) Int. Cl. G06N 20/00

(52) U.S. Cl. CPC G06N 20/00

(57) ABSTRACT

There are provided measures for enhancement of training node selection for trustworthy federated learning. Such measures exemplarily comprise, at a first network entity coordinating artificial intelligence or machine learning contributor selection in a network, receiving, respectively from a first and a second of a plurality of second network entities managing artificial intelligence or machine learning trustworthiness in artificial intelligence or machine learning pipelines in said network, a first/second artificial intelligence or machine learning contributor selection conflict resolution request including a first/second federated learning distributed node candidate list including at least one first/second federated learning distributed node in said network, wherein each of said at least one first/second federated learning distributed node has trustworthiness capabilities satisfying first/second artificial intelligence or machine learning trustworthiness requirement criteria and is associated with a respective rank in said first/second federated learning distributed node candidate list, transmitting, respectively towards said first and said second of said plurality of second network entities, a first/second artificial intelligence or machine learning contributor selection conflict resolution response including an updated first/second federated learning distributed node candidate list removing a conflict between said first federated learning distributed node candidate list and said second federated learning distributed node candidate list.

### FIELD

Various example embodiments relate to enhancement of training node selection for trustworthy federated learning. More specifically, various example embodiments exemplarily relate to measures (including methods, apparatuses and computer program products) for realizing enhancement of training node selection for trustworthy federated learning.

### BACKGROUND

The present specification generally relates to federated learning implementations under consideration of artificial intelligence (AI)/machine learning (ML) model trustworthiness in particular for interoperable and multi-vendor environments.

An AI or ML pipeline helps to automate AI/ML workflows by splitting them into independent, reusable and modular components that can then be pipelined together to create a (AI/ML) model. An AI/ML pipeline is not a one-way flow, i.e., it is iterative, and every step is repeated to continuously improve the accuracy of the model.

FIG. 7 shows a schematic diagram of an example of an AI/ML pipeline.

An AI/ML workflow might consist of at least the following three components illustrated in FIG. 7, namely, a data source manager (e.g., data collection, data preparation), a model training manager (e.g., hyperparameter tuning), and a model inference manager (e.g., model evaluation).

With AI/ML pipelining and the recent push for microservices architectures (e.g., container virtualization), each AI/ML workflow component is abstracted into an independent service that relevant stakeholders (e.g., data engineers, data scientists) can independently work on.

Besides, an AI/ML pipeline orchestrator shown in FIG. 7 can manage the AI/ML pipelines' lifecycle (e.g., commissioning, scaling, decommissioning).

Subsequently, some basics of trustworthy artificial intelligence are explained.

For AI/ML systems to be widely accepted, they should be trustworthy in addition to their performance (e.g., accuracy).

The European Commission has proposed the first-ever legal framework on AI, presenting new rules for AI to be trustworthy (based on the risk levels), which the companies deploying mission-critical AI-based systems must adhere to in the near future.

The High-level Expert Group (HLEG) on AI has developed the European Commission's Trustworthy AI (TAI) strategy. In the deliverable ‘Ethics Guidelines for Trustworthy AI’ released in April 2019, the group has listed seven critical requirements that the AI systems should meet to be considered trustworthy:
1. Transparency: Include traceability, explainability and communication.
2. Diversity, non-discrimination and fairness: Include the avoidance of unfair bias, accessibility and universal design, and stakeholder participation.
3. Technical robustness and safety: Include resilience to attack and security, fall back plan and general safety, accuracy, reliability and reproducibility.
4. Privacy and data governance: Include respect for privacy, quality and integrity of data, and access to data.
5. Accountability: Include auditability, minimization and reporting of negative impact, trade-offs and redress.
6. Human agency and oversight: Include fundamental rights, human agency and human oversight.
7. Societal and environmental wellbeing: Include sustainability and environmental friendliness, social impact, society and democracy.

Additionally, the International Organization for Standardization (ISO)/International Electrotechnical Commission (IEC) has also published a technical report on ‘Overview of trustworthiness in artificial intelligence’. Early efforts in the open-source community are also visible towards developing TAI frameworks/tools/libraries such as IBM AI360, Google Explainable AI and TensorFlow Responsible AI.

Three key TAI aspects and associated definitions/algorithms/metrics described e.g. in the AI/ML research community are introduced below:
1. Fairness: Fairness is the process of understanding bias introduced in the data, and ensuring that the model provides equitable predictions across all demographic groups. It is important to apply fairness analysis throughout the entire AI/ML pipeline, making sure to continuously re-evaluate the models from the perspective of fairness and inclusion. This is especially important when AI/ML is deployed in critical business processes that affect a wide range of end users. There are three broad approaches to detect bias in the AI/ML model:
   a. Pre-processing fairness—To detect bias in the AI/ML training data using algorithms such as Reweighing and Disparate impact remover.
   b. In-processing fairness—To detect bias in the AI/ML model generation using algorithms such as Prejudice Remover and Adversarial debiasing.
   c. Post-processing fairness—To detect bias in the AI/ML model decisions using algorithms such as Odds-equalizing and Reject option classification.
   Quantification of Fairness—There are several metrics that measure individual and group fairness, for example, Statistical Parity Difference, Average Odds Difference, Disparate Impact and Theil Index.
2. Explainability: Explainability of an AI/ML model refers to unveiling of the black box model, which just makes the prediction or gives the recommendation, to the white box, which actually gives the details of the underlying mechanism and pattern identified by the model for a particular dataset. There are multiple reasons why it is necessary to understand the underlying mechanism of an AI/ML model such as human readability, justifiability, interpretability and bias mitigation. There are three broad approaches to design an ML model to be explainable:
   a. Pre-modelling explainability—To understand or describe data used to develop AI/ML models, for example, using algorithms such as ProtoDash and Disentangled Inferred Prior Variational Autoencoder Explainer.
   b. Explainable modelling/Interpretable modelling—To develop more explainable AI/ML models, e.g., ML models with joint prediction and explanation or surrogate explainable models, for example, using algorithms such as Generalized Linear Rule Models and Teaching Explainable Decisions (TED).
   c. Post-modelling explainability—To extract explanations from pre-developed AI/ML models, for example, using algorithms such as ProtoDash, Contrastive Explanations Method, Profweight, LIME and SHAP.
   Furthermore, explanations can be local (i.e., explaining a single instance/prediction) or global (i.e., explaining the global AI/ML model structure/predictions, e.g., based on combining many local explanations of each prediction).
   Quantification of Explainability—Although it is ultimately the consumer who determines the quality of an explanation, the research community has proposed quantitative metrics as proxies for explainability. There are several metrics that measure explainability such as Faithfulness and Monotonicity.
3. Robustness (adversarial): There are four adversarial threats that any AI/ML model developers/scientists need to consider for defending and evaluating their AI/ML models and applications.
   a. Evasion: Evasion attacks involve carefully perturbing the input samples at test time to have them misclassified, for example, using techniques such as Shadow attack and Threshold attack.
   b. Poisoning: Poisoning is adversarial contamination of training data. Machine learning systems can be re-trained using data collected during operations. An attacker may poison this data by injecting malicious samples during operation that subsequently disrupt retraining, for example, using techniques such as Backdoor attack and Adversarial backdoor embedding.
   c. Extraction: Extraction attacks aim to duplicate a machine learning model through query access to a target model, for example, using techniques such as KnockoffNets and Functionally equivalent extraction.
   d. Inference: Inference attacks determine if a sample of data was used in the training dataset of an AI/ML model, for example, using techniques such as Membership inference black-box and attribute inference black-box.
   In addition to adversarial robustness, there are other aspects of AI/ML robustness such as dealing with missing data, erroneous data, confidence levels of data etc., which need to be addressed.
   There are a number of approaches to defend AI/ML models against such adversarial attacks at each stage of the AI/ML design:
      a. Preprocessor—For example, using techniques such as InverseGAN and DefenseGAN.
      b. Postprocessor—For example, using techniques such as Reverse sigmoid and Rounding.
      c. Trainer—For example, using techniques such as General adversarial training and Madry's protocol.
      d. Transformer—For example, using techniques such as Defensive distillation and Neural cleanse.
      e. Detector—For example, using techniques such as Detection based on activations analysis and Detection based on spectral signatures.
   Quantification of Robustness: There are several metrics that measure robustness of ML models such as Empirical Robustness and Loss Sensitivity.

Learning processing is a necessary component when producing an AI/ML model.

One approach of such learning processing is federated learning (FL).

Typical ML approaches require centralizing of all the data that are collected by distributed nodes on one single central node for training. To minimize the data exchange between the distributed nodes and the central node where the model training is usually done, FL is introduced. In FL, instead of training a model at the central node, different versions of the model are trained at different distributed nodes (i.e., considering each distributed node has its own local data) in an iterative manner. During each iteration, the central node (referred to as FL Aggregator in the following) aggregates local models that are partially trained at the distributed nodes. Then, a consolidated single global model is sent back to the distributed nodes. This process is repeated until the global model eventually converges. The iterative FL process can generally be summarized with the following four steps:
Step 1: Local training—The FL Aggregator (i.e. the central node) selects and asks K distributed nodes to download a trainable model from the FL Aggregator. All K distributed nodes compute training gradients or model parameters and send locally trained model parameters to the FL Aggregator.
Step 2: Model aggregating—The FL Aggregator performs aggregation of the uploaded model parameters from K distributed nodes.
Step 3: Parameters broadcasting—The FL Aggregator broadcasts the aggregated model parameters to the K distributed nodes.
Step 4: Model updating-All K distributed nodes update their respective local models with the received aggregated parameters and examines the performance of updated models.

After several local training and update exchanges between the FL Aggregator and its associated K distributed nodes, it is possible to achieve a global optimal learning model.

In FL, for each iteration of the training process, the FL aggregator (i.e., the central node) selects the distributed nodes that can participate in the training process. Currently, the selection of distributed nodes is either random or based on performance criteria such as resource availability at the distributed nodes, link quality to the distributed nodes, etc., which directly impacts the achieved FL model performance (e.g., accuracy), and/or based on AI/ML trustworthy capabilities of the distributed nodes, which directly impacts the achieved FL model trustworthiness (e.g. explainability).

An FL aggregator is specific to a use case/service. It is noted that, depending on the criticality of the use case, AI/ML trustworthy requirements may vary, and the FL aggregator may select training nodes that are capable of meeting the AI/ML trustworthy requirements.

FIG. 11 shows a schematic diagram of an example of a system environment with signaling variants, and in particular illustrates an example scenario where two FL aggregators are performing training node selection based on at least AI/ML trustworthy requirements of respective use cases/services. FL Aggregator 1 is responsible for high-risk service 1, whereas FL Aggregator 2 is responsible for low-risk service 2. Furthermore, Distributed Node 1 to Distributed Node 3 and Distributed Node 3 to Distributed Node 5 are considered to be under the coverage of FL Aggregator 1 and FL Aggregator 2, respectively. Distributed Node 3, which is under the coverage of both FL aggregators, is assumed to have high AI/ML trustworthy capability to meet the requirements of both services, however not concurrently due to e.g. its onboard resource constraints.

Currently, the FL Aggregators do not communicate with each other during the selection of candidate nodes for FL training. Consequently, for an FL training iteration, it is very likely that the FL aggregators (e.g., FL Aggregator 1 and FL Aggregator 2) may select the same (or set of) distributed node(s) (e.g., Distributed Node 3) as the candidate training node based on the AI/ML trustworthy capability information received from the distributed nodes.

However, a distributed node may not be able to participate in FL training for both use cases, concurrently, due to its inability to meet AI/ML trustworthy requirements, e.g., because of lack of resources in the distributed node. As a result, in FIG. 11, the FL Aggregator 2 belonging to low-risk service may select and block (or engage) the Distributed Node 3 with high trustworthy capabilities causing the FL Aggregator 1 belonging to high-risk service not being able to select the Distributed Node 3, which is not ideal or desirable. In the present specification, the selection and/or consideration (as a candidate training node) of the same distributed node by two or more FL aggregators is referred as training node selection conflict (or just conflict).

In view of the above, the problem arises that there is no mechanism to detect and prevent/resolve such conflicts for optimal training nodes selection for FL training across use cases/services (or AI/ML pipelines) when multiple FL aggregators are performing the training node selection on the overlapping set of distributed nodes.

Hence, there is a need to provide for enhancement of training node selection for trustworthy federated learning.

### SUMMARY

Various example embodiments aim at addressing at least part of the above issues and/or problems and drawbacks.

Various aspects of example embodiments are set out in the appended claims.

According to an exemplary aspect, there is provided a method of a first network entity coordinating artificial intelligence or machine learning contributor selection in a network, the method comprising receiving, from a first of a plurality of second network entities managing artificial intelligence or machine learning trustworthiness in artificial intelligence or machine learning pipelines in said network, a first artificial intelligence or machine learning contributor selection conflict resolution request including a first federated learning distributed node candidate list including at least one first federated learning distributed node in said network, wherein each of said at least one first federated learning distributed node has trustworthiness capabilities satisfying first artificial intelligence or machine learning trustworthiness requirement criteria and is associated with a respective rank in said first federated learning distributed node candidate list, receiving, from a second of said plurality of second network entities, a second artificial intelligence or machine learning contributor selection conflict resolution request including a second federated learning distributed node candidate list including at least one second federated learning distributed node in said network, wherein each of said at least one second federated learning distributed node has trustworthiness capabilities satisfying second artificial intelligence or machine learning trustworthiness requirement criteria and is associated with a respective rank in said second federated learning distributed node candidate list, transmitting, towards said first of said plurality of second network entities, a first artificial intelligence or machine learning contributor selection conflict resolution response including an updated first federated learning distributed node candidate list removing a conflict between said first federated learning distributed node candidate list and said second federated learning distributed node candidate list, and transmitting, towards said second of said plurality of second network entities, a second artificial intelligence or machine learning contributor selection conflict resolution response including an updated second federated learning distributed node candidate list removing said conflict between said first federated learning distributed node candidate list and said second federated learning distributed node candidate list.

According to an exemplary aspect, there is provided a method of a second network entity managing artificial intelligence or machine learning trustworthiness in artificial intelligence or machine learning pipelines in a network, the method comprising obtaining a federated learning distributed node candidate list including at least one federated learning distributed node in said network, wherein each of said at least one federated learning distributed node has trustworthiness capabilities satisfying artificial intelligence or machine learning trustworthiness requirement criteria and is associated with a respective rank in said federated learning distributed node candidate list, and transmitting, towards a first network entity coordinating artificial intelligence or machine learning contributor selection in said network, an artificial intelligence or machine learning contributor selection conflict resolution request including said federated learning distributed node candidate list.

According to an exemplary aspect, there is provided an apparatus of a first network entity coordinating artificial intelligence or machine learning contributor selection in a network, the apparatus comprising receiving circuitry configured to receive, from a first of a plurality of second network entities managing artificial intelligence or machine learning trustworthiness in artificial intelligence or machine learning pipelines in said network, a first artificial intelligence or machine learning contributor selection conflict resolution request including a first federated learning distributed node candidate list including at least one first federated learning distributed node in said network, wherein each of said at least one first federated learning distributed node has trustworthiness capabilities satisfying first artificial intelligence or machine learning trustworthiness requirement criteria and is associated with a respective rank in said first federated learning distributed node candidate list, and to receive, from a second of said plurality of second network entities, a second artificial intelligence or machine learning contributor selection conflict resolution request including a second federated learning distributed node candidate list including at least one second federated learning distributed node in said network, wherein each of said at least one second federated learning distributed node has trustworthiness capabilities satisfying second artificial intelligence or machine learning trustworthiness requirement criteria and is associated with a respective rank in said second federated learning distributed node candidate list, and transmitting circuitry configured to transmit, towards said first of said plurality of second network entities, a first artificial intelligence or machine learning contributor selection conflict resolution response including an updated first federated learning distributed node candidate list removing a conflict between said first federated learning distributed node candidate list and said second federated learning distributed node candidate list, and to transmit, towards said second of said plurality of second network entities, a second artificial intelligence or machine learning contributor selection conflict resolution response including an updated second federated learning distributed node candidate list removing said conflict between said first federated learning distributed node candidate list and said second federated learning distributed node candidate list.

According to an exemplary aspect, there is provided an apparatus of a second network entity managing artificial intelligence or machine learning trustworthiness in artificial intelligence or machine learning pipelines in a network, the apparatus comprising obtaining circuitry configured to obtain a federated learning distributed node candidate list including at least one federated learning distributed node in said network, wherein each of said at least one federated learning distributed node has trustworthiness capabilities satisfying artificial intelligence or machine learning trustworthiness requirement criteria and is associated with a respective rank in said federated learning distributed node candidate list, and transmitting circuitry configured to transmit, towards a first network entity coordinating artificial intelligence or machine learning contributor selection in said network, an artificial intelligence or machine learning contributor selection conflict resolution request including said federated learning distributed node candidate list.

According to an exemplary aspect, there is provided an apparatus of a first network entity coordinating artificial intelligence or machine learning contributor selection in a network, the apparatus comprising at least one processor, at least one memory including computer program code, and at least one interface configured for communication with at least another apparatus, the at least one processor, with the at least one memory and the computer program code, being configured to cause the apparatus to perform receiving, from a first of a plurality of second network entities managing artificial intelligence or machine learning trustworthiness in artificial intelligence or machine learning pipelines in said network, a first artificial intelligence or machine learning contributor selection conflict resolution request including a first federated learning distributed node candidate list including at least one first federated learning distributed node in said network, wherein each of said at least one first federated learning distributed node has trustworthiness capabilities satisfying first artificial intelligence or machine learning trustworthiness requirement criteria and is associated with a respective rank in said first federated learning distributed node candidate list, receiving, from a second of said plurality of second network entities, a second artificial intelligence or machine learning contributor selection conflict resolution request including a second federated learning distributed node candidate list including at least one second federated learning distributed node in said network, wherein each of said at least one second federated learning distributed node has trustworthiness capabilities satisfying second artificial intelligence or machine learning trustworthiness requirement criteria and is associated with a respective rank in said second federated learning distributed node candidate list, transmitting, towards said first of said plurality of second network entities, a first artificial intelligence or machine learning contributor selection conflict resolution response including an updated first federated learning distributed node candidate list removing a conflict between said first federated learning distributed node candidate list and said second federated learning distributed node candidate list, and transmitting, towards said second of said plurality of second network entities, a second artificial intelligence or machine learning contributor selection conflict resolution response including an updated second federated learning distributed node candidate list removing said conflict between said first federated learning distributed node candidate list and said second federated learning distributed node candidate list.

According to an exemplary aspect, there is provided an apparatus of a second network entity managing artificial intelligence or machine learning trustworthiness in artificial intelligence or machine learning pipelines in a network, the apparatus comprising at least one processor, at least one memory including computer program code, and at least one interface configured for communication with at least another apparatus, the at least one processor, with the at least one memory and the computer program code, being configured to cause the apparatus to perform obtaining a federated learning distributed node candidate list including at least one federated learning distributed node in said network, wherein each of said at least one federated learning distributed node has trustworthiness capabilities satisfying artificial intelligence or machine learning trustworthiness requirement criteria and is associated with a respective rank in said federated learning distributed node candidate list, and transmitting, towards a first network entity coordinating artificial intelligence or machine learning contributor selection in said network, an artificial intelligence or machine learning contributor selection conflict resolution request including said federated learning distributed node candidate list.

According to an exemplary aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient detection and resolution of above-identified training node selection conflicts in relation to trustworthy FL to thereby solve at least part of the problems and drawbacks identified in relation to the prior art.

By way of example embodiments, there is provided enhancement of training node selection for trustworthy federated learning. More specifically, by way of example embodiments, there are provided measures and mechanisms for realizing enhancement of training node selection for trustworthy federated learning. In particular, by way of example embodiments, there are provided measures and mechanisms for conflict detection and resolution in training node selection for trustworthy federated learning.

Thus, improvement is achieved by methods, apparatuses and computer program products enabling/realizing enhancement of training node selection for trustworthy federated learning.

### BRIEF DESCRIPTION OF THE DRAWINGS

In the following, the present disclosure will be described in greater detail by way of non-limiting examples with reference to the accompanying drawings, in which

FIG. 1 is a block diagram illustrating an apparatus according to example embodiments,

FIG. 2 is a block diagram illustrating an apparatus according to example embodiments,

FIG. 3 is a block diagram illustrating an apparatus according to example embodiments,

FIG. 4 is a block diagram illustrating an apparatus according to example embodiments,

FIG. 5 is a schematic diagram of a procedure according to example embodiments,

FIG. 6 is a schematic diagram of a procedure according to example embodiments,

FIG. 7 is a schematic diagram illustrating an exemplary structure of an artificial intelligence/machine learning pipeline,

FIG. 8 shows a schematic diagram of an example of a system environment with signaling variants according to example embodiments,

FIG. 9 shows a schematic diagram of signaling sequences according to example embodiments,

FIG. 10 shows a schematic diagram of an example of a system environment with signaling variants according to example embodiments,

FIG. 11 shows a schematic diagram of an example of a system environment with signaling variants,

FIG. 12 shows a schematic diagram of an example of a system environment with signaling variants according to example embodiments,

FIG. 13 (FIGS. 13A and 13B) shows a schematic diagram of signaling sequences according to example embodiments, and

FIG. 14 is a block diagram alternatively illustrating apparatuses according to example embodiments.

### DETAILED DESCRIPTION

The present disclosure is described herein with reference to particular non-limiting examples and to what are presently considered to be conceivable embodiments.

A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology which is directly related thereto. Such terminology is only used in the context of the presented non-limiting examples, and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to example embodiments, in general terms, there are provided measures and mechanisms for (enabling/realizing) enhancement of training node selection for trustworthy federated learning. In particular, according to example embodiments, in general terms, there are provided measures and mechanisms for (enabling/realizing) conflict detection and resolution in training node selection for trustworthy federated learning.

A framework for TAI in cognitive autonomous networks (CAN) underlies example embodiments.

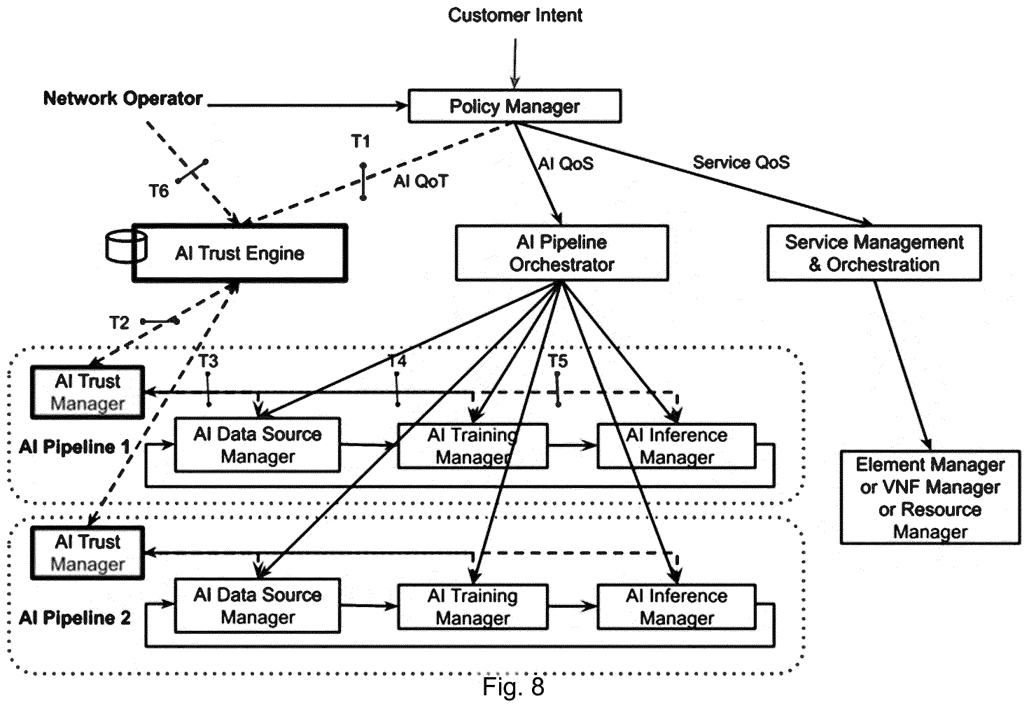

FIG. 8 shows a schematic diagram of an example of a system environment with interfaces and signaling variants according to example embodiments, and in particular illustrates example details of the trustworthy artificial intelligence framework (TAIF) in CANs underlying example embodiments.

Such TAIF for CANs may be provided to facilitate the definition, configuration, monitoring and measuring of AI/ML model trustworthiness (e.g., fairness, explainability and robustness) for interoperable and multi-vendor environments. A service definition or the business/customer intent may include AI/ML trustworthiness requirements in addition to network/AI quality of service (QOS) requirements, and the TAIF may be used to configure the requested AI/ML trustworthiness and to monitor and assure its fulfilment. The TAIF introduces two management functions, namely, a function entity named AI Trust Engine (one per management domain) and a function entity named AI Trust Manager (one per AI/ML pipeline). The TAIF further introduces six interfaces (named T1 to T6) that support interactions in the TAIF. According to the TAIF underlying example embodiments, the AI Trust Engine is center for managing all AI trustworthiness related things in the network, whereas the AI Trust Managers are use case and often vendor specific, with knowledge of the AI use case and how it is implemented.

Furthermore, the TAIF underlying example embodiments introduces a concept of AI quality of trustworthiness (AI QoT) (as in the table below (“Table 1: AI QoT class identifiers for TAI in CANs”)) to define AI/ML model trustworthiness in a unified way covering three factors, i.e., fairness, explainability and robustness, similar to how QoS is used for network performance.

TABLE 1
AI QoT class identifiers for TAI in CANs

| | | | Explainability | |
|---|---|---|---|---|
| | | | (Qualitative- | |
| | | | e.g., | |
| | | | explainable | |
| | | Fairness | model & | Robustness |
| | | (Quantitative- | Quantitative- | (Quantitative- |
| | Example | e.g., Theil | e.g., | e.g., Loss |
| AI QoT | Services | Index) | Faithfulness) | Sensitivity) |
| Class 1 | Autonomous | High | Very High | Very High |
| | Driving | | | |
| . | . | . | . | . |
| . | . | . | . | . |
| . | . | . | . | . |
| Class N | Movie | Low | Very Low | Low |
| | Streaming | | | |

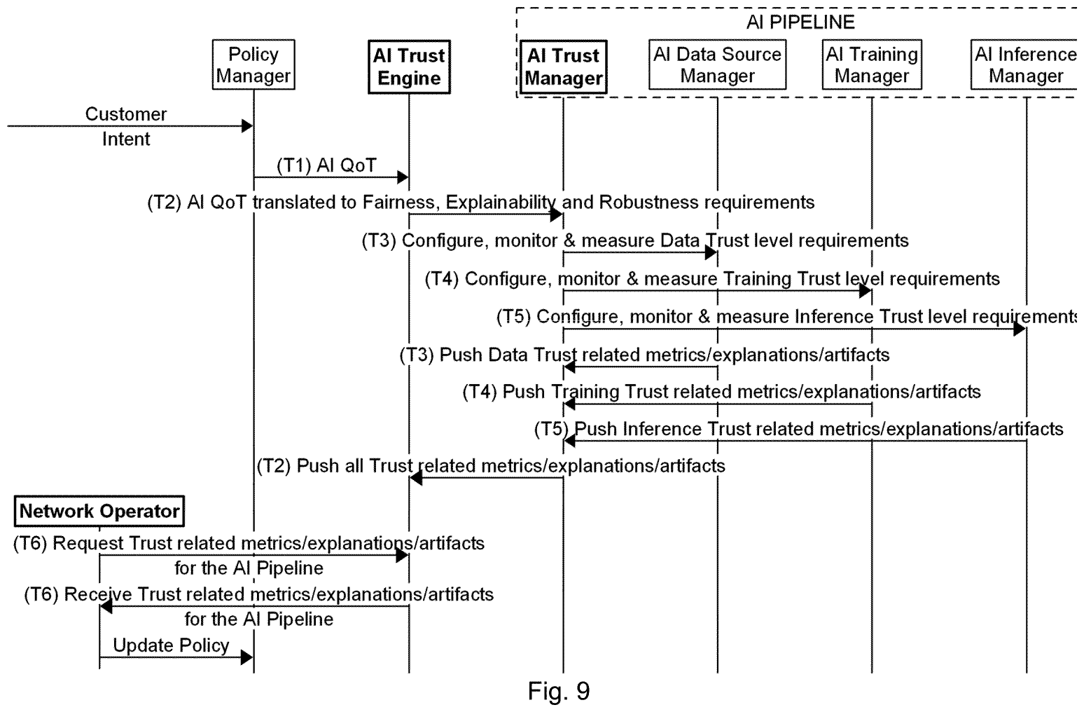

FIG. 9 shows a schematic diagram of signaling sequences according to example embodiments, and in particular illustrates an exemplary generic workflow in the TAIF underlying example embodiments.

According to the high-level generic workflow within the TAIF illustrated in FIG. 9, the network operator can specify, over the T1 interface, the required AI QoT (use case-specific e.g. based on risk levels) to the AI Trust Engine via e.g. a Policy Manager. The AI Trust Engine translates the AI QoT into specific AI trustworthiness (i.e., fairness, explainability and robustness) requirements and identifies the affected use-case-specific AI Trust Manager(s). Using the T2 interface, the AI Trust Engine may configure the AI Trust Managers. The use case specific and implementation-aware AI Trust Manager may configure, monitor, and measure AI trustworthiness requirements for an AI Data Source Manager, an AI Training Manager and an AI Inference Manager (of a respective AI pipeline) over T3, T4 and T5 interfaces, respectively. The measured or collected TAI metrics and/or TAI explanations from the AI Data Source Manager, AI Training Manager and AI Inference Manager regarding the AI pipeline may be pushed to the AI Trust Manager over T3, T4 and T5 interfaces, respectively. The AI Trust Manager may push the TAI metrics and/or TAI explanations to the AI Trust Engine, over the T2 interface, based on the reporting mechanisms configured by the AI Trust Engine. Finally, the network operator can request and receive the TAI metrics/explanations of an AI pipeline from the AI Trust Engine over the T6 interface. Based on the information retrieved, the Network Operator may decide to update the policy via the Policy Manager.

Further principles of trustworthy FL based on a trustworthy AI framework, in particular on the TAIF underlying example embodiments, are explained below.

In FL, for each iteration of the training process, the FL aggregator (i.e., the central node) selects the distributed nodes that can participate in the training process. Currently, the selection of distributed nodes is either random or based on various criteria such as resource availability at the distributed nodes, link quality to the distributed nodes, etc., which directly impacts the achieved FL model performance (e.g., accuracy). However, for AI/ML systems to be widely accepted/adopted and to abide by the regulatory requirements, they should also be trustworthy in addition to their improved performance (e.g., accuracy). For FL to be trustworthy (i.e. to meet the trustworthy requirements), it is crucial that the distributed nodes which are participating in the local training offer the required AI/ML trustworthy capabilities. Hence, given a trustworthiness requirement e.g., AI QoT, the FL aggregator must select only those distributed nodes as training nodes which have the AI/ML trustworthy capabilities to meet the desired AI QoT in the AI pipeline.

The TAIF underlying example embodiments may support trustworthy FL in CANs. The FL aggregator may be made aware of the distributed nodes that meet the AI/ML trustworthy requirements of the targeted use case. Then, the FL aggregator may select the distributed nodes for FL training based on trustworthy capabilities of the distributed nodes to ensure trustworthy FL. It is noted that the FL aggregator may also consider various other criteria such as resource availability at the distributed nodes, link quality to the distributed nodes, etc., in addition to trustworthy capabilities of the distributed nodes.

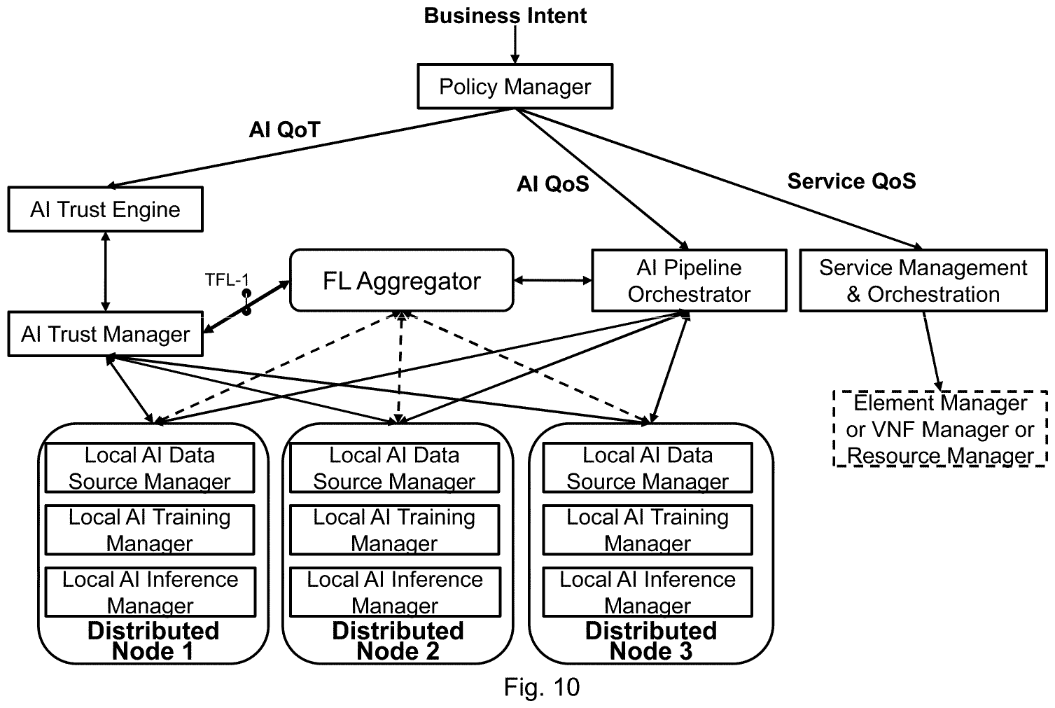

FIG. 10 shows a schematic diagram of an example of a system environment with signaling variants according to example embodiments, and in particular illustrates trustworthy FL in CANs.

As illustrated in FIG. 10, in the TAIF underlying example embodiments, each distributed node (e.g., Distributed Node 1 to Distributed Node 3) may contain a local AI Data Source Manager, a local AI Training Manager, and a local AI Inference Manager. The AI Trust Manager may request and acquire the AI/ML trustworthy capabilities (e.g., fairness, explainability, robustness) of all these distributed nodes (via T3, T4 and T5 interfaces, as depicted in FIG. 8). Moreover, the AI Trust Manager may also obtain the trustworthy requirement (e.g., fairness, explainability, robustness) for the use case from the AI Trust Engine via the T2 interface. Then, to enable the AI Trust Manager to communicate the acquired AI/ML trustworthy capabilities of the distributed nodes to the FL Aggregator and to allow the FL Aggregator to select only those distributed nodes as training nodes which have the AI/ML trustworthy capabilities to meet the desired AI QoT in local training:
1. An interface (i.e., TFL-1 interface as shown in FIG. 10) may be provided between the AI Trust Manager and the FL Aggregator to support the exchange of information concerning the AI/ML trustworthy capabilities of the distributed nodes.
2. The FL Aggregator may notify the AI Trust Manager (via TFL-1 interface) about those distributed nodes that it is seeking for information on their AI/ML trustworthy capabilities.
3. Once the AI Trust Manager requests and acquires the AI/ML trustworthy capabilities from the distributed nodes, the AI Trust Manager may rank (e.g., order of preference) these distributed nodes based on their AI/ML trustworthy capabilities considering the desired AI QoT level. The ranking can also be based on individual AI/ML trustworthy capabilities (i.e., fairness-based ranking, explainability-based ranking, robustness-based ranking, reliability-based ranking). Additionally, the AI Trust Manager may also consider the AI/ML trustworthy metrics of the local data (e.g., fairness) contained in the individual distributed nodes to rank the distributed nodes.
4. The AI Trust Manager may report the constructed ranking list(s) (from 3 above) concerning the AI/ML trustworthy capabilities of the distributed nodes to the FL Aggregator via the TFL-1 interface.
5. The FL aggregator may consider the ranking list(s) received from the AI Trust Manager in the distributed node selection scheme for the next iteration of the FL training process so that the trustworthy capabilities of the selected distributed nodes meet the trustworthy requirements of the targeted use case.
6. The FL Aggregator may notify about the selected distributed nodes for the next iteration of the FL training process to the AI Trust Manager via TFL-1 interface.

However, in particular the TAIF underlying example embodiments as discussed above does not provide a mechanism to detect and prevent/resolve conflicts for optimal training nodes selection for FL training across use cases/services (or AI/ML pipelines) when multiple FL aggregators are performing the training node selection on the overlapping set of distributed nodes.

Hence, in brief, according to example embodiments, detection and resolution of training node selection conflicts for trustworthy FL is provided.

In particular, in brief, according to example embodiments, a mechanism to detect and resolve training node selection conflicts when multiple FL aggregators corresponding to various use cases (of different AI/ML trustworthy requirements) are selecting distributed nodes as training nodes for trustworthy FL from a set of distributed nodes is introduced.

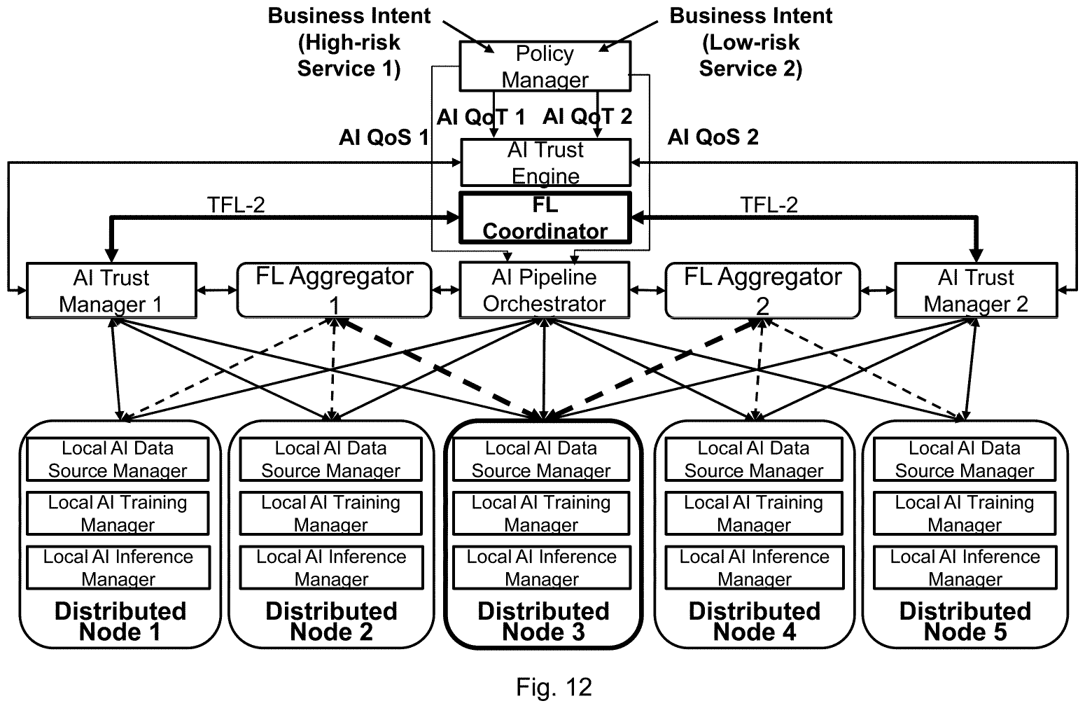

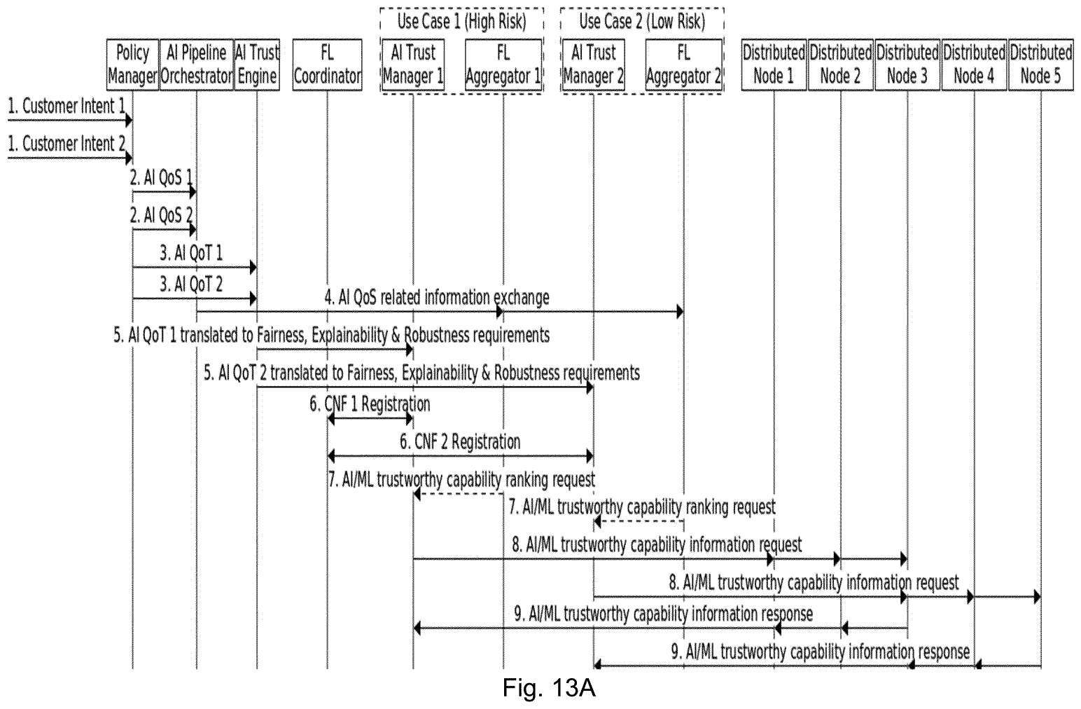

FIG. 12 shows a schematic diagram of an example of a system environment with signaling variants according to example embodiments, and in particular illustrates training node selection conflict detection and resolution in trustworthy FL according to example embodiments.

As shown in FIG. 12, a management function, named herein as FL Coordinator, and an interface, named herein as TFL-2 to support the interaction between the FL Coordinator and various FL Aggregators, are introduced.

According to example embodiments, the FL Coordinator may support the following four basic operations:
Operation 1: Collect from each AI Trust Manager (via TFL-2 interface) the following information:
   Desired AI QoT class identifier and/or the fairness, explainability and robustness requirements for the use case (CNF) as indicated by the corresponding AI Trust Engine.
   TAI capability information (e.g., in the form of a ranking list) of the candidate training nodes that are indicated by the corresponding FL Aggregator.
   Distributed nodes that have been indicated as selected/blocked for a particular (or set of) iteration(s) by the corresponding FL Aggregator.
Operation 2: Conflict Identification in training node selection:
   Based on the collected information (from operation 1), identify if more than one FL Aggregator(s) are indicating the same (or set of) distributed node(s) as candidate training node(s) for next iteration(s). Then, the training node selection at two or more FL aggregators is said to be conflicted if those FL aggregators have indicated the same (or set of) distributed node(s) as candidate training node(s) for next iteration(s).
Operation 3: Conflict Resolution in training node selection:
   Based on the collected information from operation 1 and the conflict identification from operation 2, the FL coordinator resolves the conflict by allowing one FL aggregator, while inhibiting other FL aggregators, to select the conflicted distributed node as the training node.
   According to example embodiments, the FL coordinator may use criticality of the services as one the decision criteria to resolve the conflict. Here, the conflicted distributed node(s) may be allowed to be selected by only the FL Aggregator that corresponds to the use case with higher AI QoT requirement (e.g. only FL Aggregator 1 may be allowed to select Distributed Node 3).
Operation 4: Inform conflict resolution outcome to each AI Trust Manager (via TFL-2 interface).

According to example embodiments, upon receiving the conflict resolution outcome from the FL coordinator (aforementioned operation 4), each AI Trust Manager shall update the status on the conflicted distributed node(s) to the corresponding FL Aggregators.

According to example embodiments, when inhibiting a FL aggregator in choosing a conflicted distributed node as a training node, an implicit indication may be sent to the FL aggregator by setting the AI/ML QoT capability for the conflicted distributed as very low (or not suitable) in the AI/ML trustworthy capability report (e.g. AI/ML trustworthy capability ranking response) sent to the FL aggregator from the AI Trust Manager.

The FL aggregators then perform training node selection by considering the updated AI/ML capability information received from the AI Trust Manager.

Example embodiments are specified below in more detail.

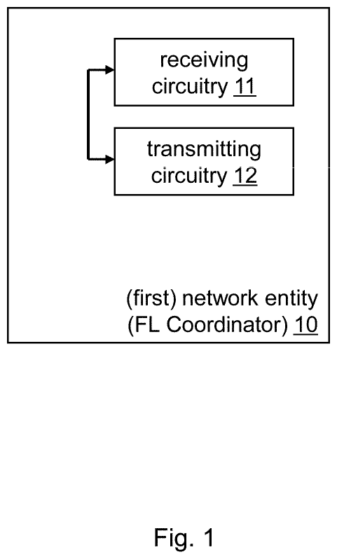

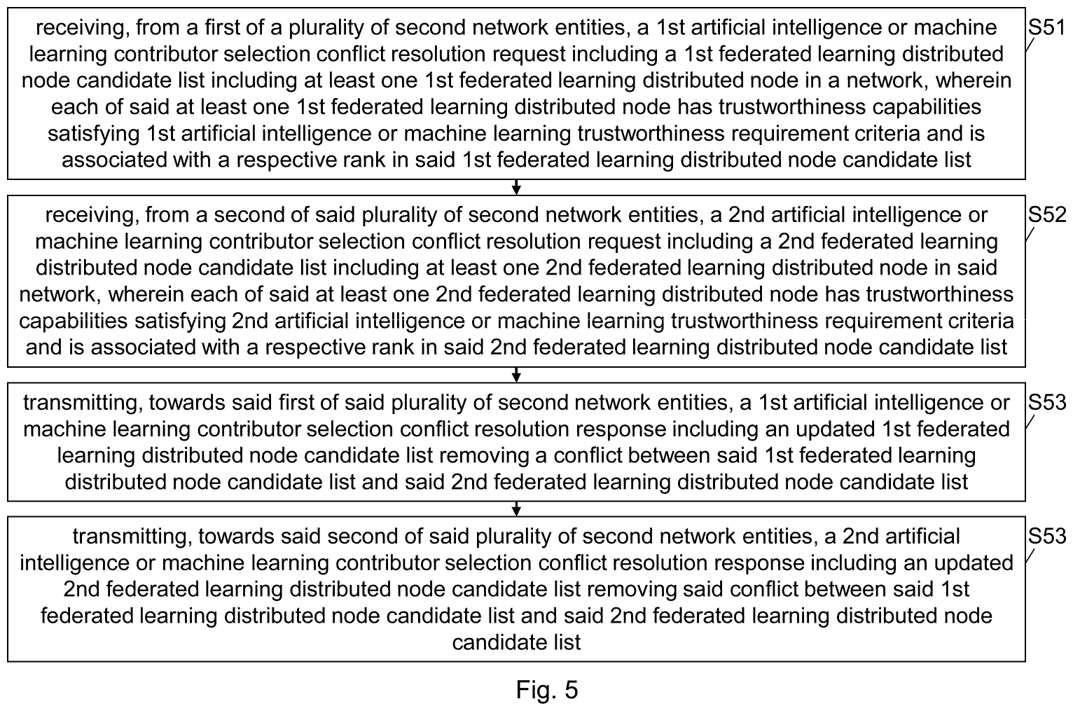

FIG. 1 is a block diagram illustrating an apparatus according to example embodiments. The apparatus may be a network node or entity 10 (first network node or entity) such as a federated learning (FL) coordinator or hosting or providing a corresponding functionality (coordinating artificial intelligence or machine learning contributor selection in a network) comprising a receiving circuitry 11 and a transmitting circuitry 12. The receiving circuitry 11 receives, from a first of a plurality of second network entities managing artificial intelligence or machine learning trustworthiness in artificial intelligence or machine learning pipelines in said network, a first artificial intelligence or machine learning contributor selection conflict resolution request including a first federated learning distributed node candidate list including at least one first federated learning distributed node in said network, wherein each of said at least one first federated learning distributed node has trustworthiness capabilities satisfying first artificial intelligence or machine learning trustworthiness requirement criteria and is associated with a respective rank in said first federated learning distributed node candidate list. The first of the plurality of second network entities may be a (first) artificial intelligence (AI) trust manager or an entity hosting or providing a corresponding functionality. The receiving circuitry 11 receives, from a second of said plurality of second network entities, a second artificial intelligence or machine learning contributor selection conflict resolution request including a second federated learning distributed node candidate list including at least one second federated learning distributed node in said network, wherein each of said at least one second federated learning distributed node has trustworthiness capabilities satisfying second artificial intelligence or machine learning trustworthiness requirement criteria and is associated with a respective rank in said second federated learning distributed node candidate list. The second of said plurality of second network entities may be a (second) artificial intelligence (AI) trust manager or an entity hosting or providing a corresponding functionality. The transmitting circuitry 12 transmits, towards said first of said plurality of second network entities, a first artificial intelligence or machine learning contributor selection conflict resolution response including an updated first federated learning distributed node candidate list removing a conflict between said first federated learning distributed node candidate list and said second federated learning distributed node candidate list. The transmitting circuitry 12 transmits, towards said second of said plurality of second network entities, a second artificial intelligence or machine learning contributor selection conflict resolution response including an updated second federated learning distributed node candidate list removing said conflict between said first federated learning distributed node candidate list and said second federated learning distributed node candidate list. FIG. 5 is a schematic diagram of a procedure according to example embodiments. The apparatus according to FIG. 1 may perform the method of FIG. 5 but is not limited to this method. The method of FIG. 5 may be performed by the apparatus of FIG. 1 but is not limited to being performed by this apparatus.

As shown in FIG. 5, a procedure according to example embodiments comprises an operation of receiving (S51), from a first of a plurality of second network entities managing artificial intelligence or machine learning trustworthiness in artificial intelligence or machine learning pipelines in said network, a first artificial intelligence or machine learning contributor selection conflict resolution request including a first federated learning distributed node candidate list including at least one first federated learning distributed node in said network, wherein each of said at least one first federated learning distributed node has trustworthiness capabilities satisfying first artificial intelligence or machine learning trustworthiness requirement criteria and is associated with a respective rank in said first federated learning distributed node candidate list, an operation of receiving (S52), from a second of said plurality of second network entities, a second artificial intelligence or machine learning contributor selection conflict resolution request including a second federated learning distributed node candidate list including at least one second federated learning distributed node in said network, wherein each of said at least one second federated learning distributed node has trustworthiness capabilities satisfying second artificial intelligence or machine learning trustworthiness requirement criteria and is associated with a respective rank in said second federated learning distributed node candidate list, an operation of transmitting (S53), towards said first of said plurality of second network entities, a first artificial intelligence or machine learning contributor selection conflict resolution response including an updated first federated learning distributed node candidate list removing a conflict between said first federated learning distributed node candidate list and said second federated learning distributed node candidate list, and an operation of transmitting (S54), towards said second of said plurality of second network entities, a second artificial intelligence or machine learning contributor selection conflict resolution response including an updated second federated learning distributed node candidate list removing said conflict between said first federated learning distributed node candidate list and said second federated learning distributed node candidate list.

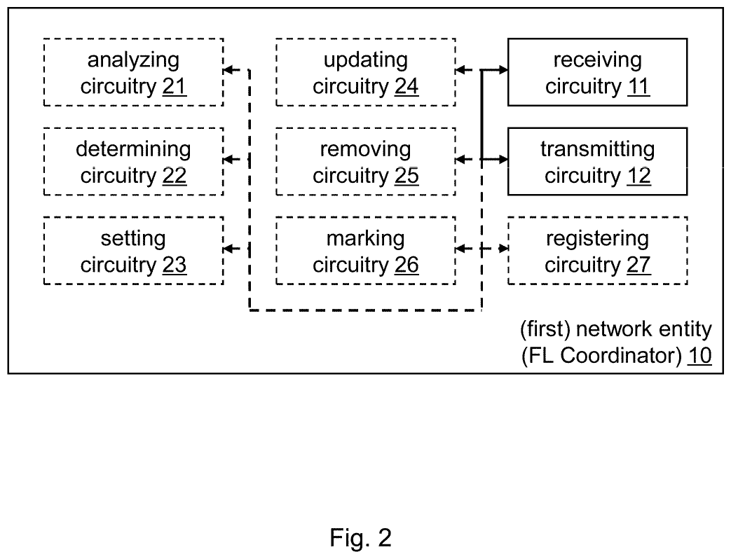

FIG. 2 is a block diagram illustrating an apparatus according to example embodiments. In particular, FIG. 2 illustrates a variation of the apparatus shown in FIG. 1. The apparatus according to FIG. 2 may thus further comprise an analyzing circuitry 21, a determining circuitry 22, a setting circuitry 23, an updating circuitry 24, a removing circuitry 25, a marking circuitry 26, and/or a registering circuitry 27.

In an embodiment at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to a variation of the procedure shown in FIG. 5, exemplary additional operations are given, which are inherently independent from each other as such. According to such variation, an exemplary method according to example embodiments may comprise an operation of analyzing said first federated learning distributed node candidate list and said second federated learning distributed node candidate list, an operation of determining, based on a result of said analyzing, whether a federated learning distributed node is present in said first federated learning distributed node candidate list and in said second federated learning distributed node candidate list, and an operation of, if said federated learning distributed node is present in said first federated learning distributed node candidate list and in said second federated learning distributed node candidate list, setting said federated learning distributed node present in said first federated learning distributed node candidate list and in said second federated learning distributed node candidate list as at least one conflicting federated learning distributed node.

According to further example embodiments, said first artificial intelligence or machine learning contributor selection conflict resolution request further includes information on said first artificial intelligence or machine learning trustworthiness requirement criteria. Alternatively, or in addition, according to further example embodiments, said second artificial intelligence or machine learning contributor selection conflict resolution request further includes information on said second artificial intelligence or machine learning trustworthiness requirement criteria.

According to further example embodiments, said first artificial intelligence or machine learning contributor selection conflict resolution request further includes information on at least one previously selected first federated learning distributed node previously selected for artificial intelligence or machine learning contribution. Alternatively, or in addition, according to further example embodiments, said second artificial intelligence or machine learning contributor selection conflict resolution request further includes information on at least one previously selected second federated learning distributed node previously selected for artificial intelligence or machine learning contribution.

According to a variation of the procedure shown in FIG. 5, exemplary additional operations are given, which are inherently independent from each other as such. According to such variation, an exemplary method according to example embodiments may comprise an operation of determining, based on a result of said analyzing, whether a federated learning distributed node is present in said first federated learning distributed node candidate list and in said at least one previously selected second federated learning distributed node, an operation of, if said federated learning distributed node is present in said first federated learning distributed node candidate list and in said at least one previously selected second federated learning distributed node, setting said federated learning distributed node present in said first federated learning distributed node candidate list and in said at least one previously selected second federated learning distributed node as said at least one conflicting federated learning distributed node, an operation of determining, based on a result of said analyzing, whether a federated learning distributed node is present in said second federated learning distributed node candidate list and in said at least one previously selected first federated learning distributed node, and an operation of, if said federated learning distributed node is present in said second federated learning distributed node candidate list and in said at least one previously selected first federated learning distributed node, setting said federated learning distributed node present in said second federated learning distributed node candidate list and in said at least one previously selected first federated learning distributed node as said at least one conflicting federated learning distributed node.

According to a variation of the procedure shown in FIG. 5, exemplary additional operations are given, which are inherently independent from each other as such. According to such variation, an exemplary method according to example embodiments may comprise an operation of updating, based on information included in said first artificial intelligence or machine learning contributor selection conflict resolution request and information included in said second artificial intelligence or machine learning contributor selection conflict resolution request, said first federated learning distributed node candidate list to generate said updated first federated learning distributed node candidate list and said second federated learning distributed node candidate list to generate said updated second federated learning distributed node candidate list.

According to a variation of the procedure shown in FIG. 5, exemplary details of the updating operation are given, which are inherently independent from each other as such. Such exemplary updating operation according to example embodiments may comprise an operation of removing, based on said information included in said first artificial intelligence or machine learning contributor selection conflict resolution request and said information included in said second artificial intelligence or machine learning contributor selection conflict resolution request, said at least one conflicting federated learning distributed node either from said first federated learning distributed node candidate list or from said second federated learning distributed node candidate list.

According to a variation of the procedure shown in FIG. 5, exemplary details of the updating operation are given, which are inherently independent from each other as such. Such exemplary updating operation according to example embodiments may comprise an operation of removing said at least one conflicting federated learning distributed node from said first federated learning distributed node candidate list, if said second artificial intelligence or machine learning trustworthiness requirement criteria are higher than said first artificial intelligence or machine learning trustworthiness requirement criteria, and an operation of removing said at least one conflicting federated learning distributed node from said second federated learning distributed node candidate list, if said first artificial intelligence or machine learning trustworthiness requirement criteria are higher than said second artificial intelligence or machine learning trustworthiness requirement criteria.

According to a variation of the procedure shown in FIG. 5, exemplary details of the updating operation are given, which are inherently independent from each other as such. Such exemplary updating operation according to example embodiments may comprise an operation of marking, based on said information included in said first artificial intelligence or machine learning contributor selection conflict resolution request and said information included in said second artificial intelligence or machine learning contributor selection conflict resolution request, said at least one conflicting federated learning distributed node either in said first federated learning distributed node candidate list or in said second federated learning distributed node candidate list as inhibited.

According to a variation of the procedure shown in FIG. 5, exemplary details of the updating operation are given, which are inherently independent from each other as such. Such exemplary updating operation according to example embodiments may comprise an operation of marking said at least one conflicting federated learning distributed node in said first federated learning distributed node candidate list as inhibited, if said second artificial intelligence or machine learning trustworthiness requirement criteria are higher than said first artificial intelligence or machine learning trustworthiness requirement criteria, and an operation of marking said at least one conflicting federated learning distributed node in said second federated learning distributed node candidate list as inhibited, if said first artificial intelligence or machine learning trustworthiness requirement criteria are higher than said second artificial intelligence or machine learning trustworthiness requirement criteria.

According to a variation of the procedure shown in FIG. 5, exemplary additional operations are given, which are inherently independent from each other as such. According to such variation, an exemplary method according to example embodiments may comprise an operation of receiving, from said first of said plurality of second network entities, a first artificial intelligence or machine learning contributor selection conflict resolution registration message, an operation of registering said first of said plurality of second network entities for artificial intelligence or machine learning contributor selection conflict resolution, an operation of receiving, from said second of said plurality of second network entities, a second artificial intelligence or machine learning contributor selection conflict resolution registration message, and an operation of registering said second of said plurality of second network entities for artificial intelligence or machine learning contributor selection conflict resolution.

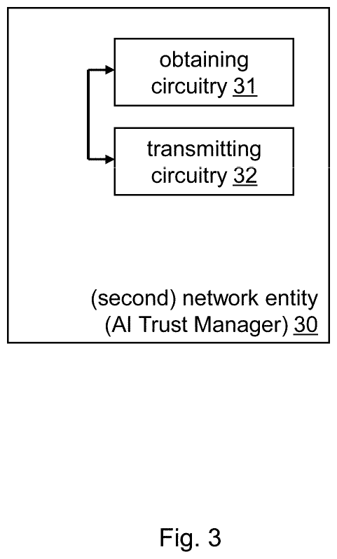

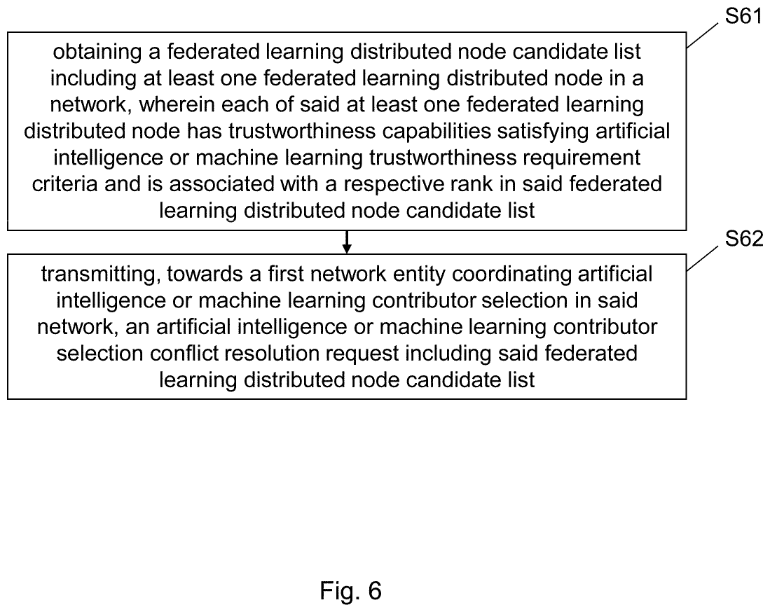

FIG. 3 is a block diagram illustrating an apparatus according to example embodiments. The apparatus may be a network node or entity 30 (second network node or entity) such as an artificial intelligence (AI) trust manager or hosting or providing a corresponding functionality (managing artificial intelligence or machine learning trustworthiness in artificial intelligence or machine learning pipelines in a network) comprising an obtaining circuitry 31 and a transmitting circuitry 32. The obtaining circuitry 31 obtains a federated learning distributed node candidate list including at least one federated learning distributed node in said network, wherein each of said at least one federated learning distributed node has trustworthiness capabilities satisfying artificial intelligence or machine learning trustworthiness requirement criteria and is associated with a respective rank in said federated learning distributed node candidate list. The transmitting circuitry 32 transmits, towards a first network entity coordinating artificial intelligence or machine learning contributor selection in said network, an artificial intelligence or machine learning contributor selection conflict resolution request including said federated learning distributed node candidate list. The first network entity may be a federated learning (FL) coordinator or an entity hosting or providing a corresponding functionality. FIG. 6 is a schematic diagram of a procedure according to example embodiments. The apparatus according to FIG. 3 may perform the method of FIG. 6 but is not limited to this method. The method of FIG. 6 may be performed by the apparatus of FIG. 3 but is not limited to being performed by this apparatus.

As shown in FIG. 6, a procedure according to example embodiments comprises an operation of obtaining (S61) a federated learning distributed node candidate list including at least one federated learning distributed node in said network, wherein each of said at least one federated learning distributed node has trustworthiness capabilities satisfying artificial intelligence or machine learning trustworthiness requirement criteria and is associated with a respective rank in said federated learning distributed node candidate list, and an operation of transmitting (S62), towards a first network entity coordinating artificial intelligence or machine learning contributor selection in said network, an artificial intelligence or machine learning contributor selection conflict resolution request including said federated learning distributed node candidate list.

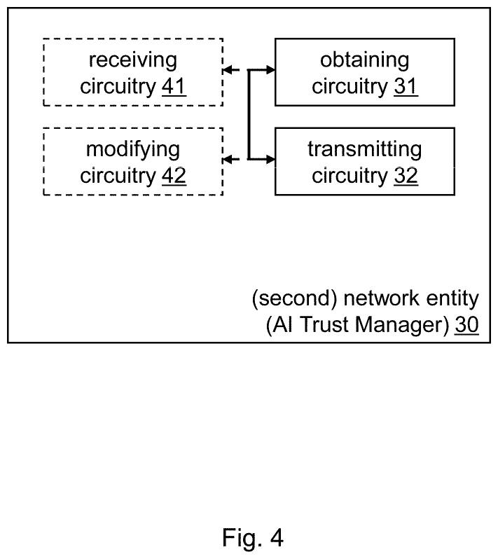

FIG. 4 is a block diagram illustrating an apparatus according to example embodiments. In particular, FIG. 4 illustrates a variation of the apparatus shown in FIG. 3. The apparatus according to FIG. 4 may thus further comprise a receiving circuitry 61 and/or a modifying circuitry 62.

In an embodiment at least some of the functionalities of the apparatus shown in FIG. 3 (or 4) may be shared between two physically separate devices forming one operational entity. Therefore, the apparatus may be seen to depict the operational entity comprising one or more physically separate devices for executing at least some of the described processes.

According to further example embodiments, said artificial intelligence or machine learning contributor selection conflict resolution request further includes information on said artificial intelligence or machine learning trustworthiness requirement criteria.

According to further example embodiments, said artificial intelligence or machine learning contributor selection conflict resolution request further includes information on at least one previously selected federated learning distributed node previously selected for artificial intelligence or machine learning contribution.

According to a variation of the procedure shown in FIG. 6, exemplary additional operations are given, which are inherently independent from each other as such. According to such variation, an exemplary method according to example embodiments may comprise an operation of receiving, from said first network entity, an artificial intelligence or machine learning contributor selection conflict resolution response including an updated federated learning distributed node candidate list, and an operation of transmitting, towards a third network entity implementing a federated learning central node in said network, said updated federated learning distributed node candidate list.

According to further example embodiments, in said updated federated learning distributed node candidate list, a conflicting federated learning distributed node of said at least one federated learning distributed node in said federated learning distributed node candidate list is removed.

According to further example embodiments, in said updated federated learning distributed node candidate list, a conflicting federated learning distributed node of said at least one federated learning distributed node in said federated learning distributed node candidate list is marked as inhibited.

According to a variation of the procedure shown in FIG. 6, exemplary additional operations are given, which are inherently independent from each other as such. According to such variation, an exemplary method according to example embodiments may comprise an operation of modifying said updated federated learning distributed node candidate list to indicate that said conflicting federated learning distributed node has insufficient trustworthiness capabilities.

Example embodiments outlined and specified above are explained below in more specific terms.

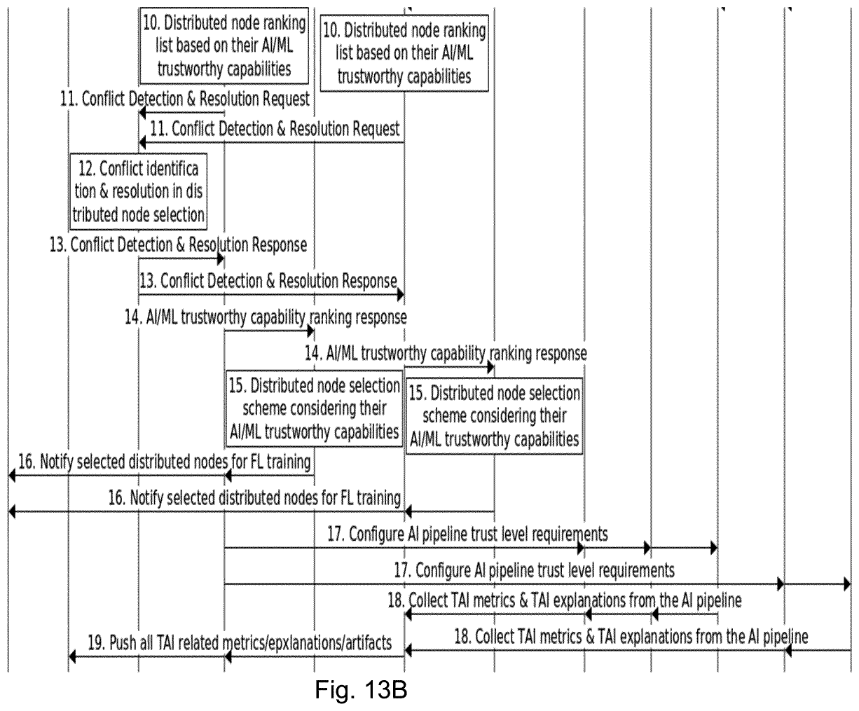

FIG. 13 (FIGS. 13A and 13B) shows a schematic diagram of signaling sequences according to example embodiments, and in particular illustrates a generic workflow for training node selection conflict detection and resolution in trustworthy FL according to example embodiments.

More specifically, FIG. 13 illustrates the step by step workflow for conflict detection and resolution in training node selection when multiple FL aggregators (corresponding to various use cases of different AI/ML trustworthy requirements) are selecting distributed nodes as training nodes for trustworthy FL from a set of distributed nodes.

In steps 1 to 3 of FIG. 13, the Policy Manager may translate the customer intent(s) into AI QoT and AI QoS requirements and send them to the AI Trust Engine and the AI Pipeline Orchestrator, respectively.

In a step 4 of FIG. 13, the AI Pipeline Orchestrator may send the AI QoS requirements to the FL Aggregator(s) of the use case-specific AI pipeline(s).

In a step 5 of FIG. 13, the AI Trust Engine may translate the AI QOT requirements into fairness, explainability and robustness requirements and send them to the AI Trust Manager(s) of the use case-specific AI pipeline(s).

In a step 6 of FIG. 13, according to example embodiments, all AI Trust Manager(s) first registers with the FL Coordinator. With this registration, the FL Coordinator is made aware of all the AI Trust Managers that seek assistance in conflict detection and resolution in training node selection for trustworthy FL.

In a step 7 of FIG. 13, the FL Aggregator(s) may determine the distributed nodes within its coverage range and provide this list of candidate training nodes (e.g., FL Aggregator 1 with Distributed Node 1 to Distributed Node 3, while FL Aggregator 2 with Distributed Node 3 to Distributed Node 5) to the AI Trust Manager(s) via TFL-1 interface requesting to check for their AI/ML trustworthy capabilities.

In steps 8 and 9 of FIG. 13, the AI Trust Manager(s) may request and acquire the AI/ML trustworthy capability information only from those distributed nodes identified by the FL Aggregator in step 7 of FIG. 13.

In a step 10 of FIG. 13, the AI Trust Manager(s) may, based on the acquired AI/ML trustworthy capability information from the distributed nodes together with the received fairness, explainability and robustness requirements for the use case from the AI Trust Engine, prepare a list of distributed nodes that satisfy the AI/ML trustworthy requirement criteria and also assign a rank to each distributed node in the list.

In a step 11 of FIG. 13, according to example embodiments, for each (or a set of) iteration(s), the AI Trust manager(s) may send to the FL Coordinator (via TFL-2 interface)
i. desired AI QoT Class Identifier and/or the fairness, explainability and robustness requirements for the use case (CNF) as indicated by the corresponding AI Trust Engine,
ii. the candidate training node ranking list (e.g. created by the AI Trust Manager(s) in step 10 of FIG. 13), and
iii. distributed nodes that have been indicated as selected/blocked for a particular (or set of) previous iteration(s) by the corresponding FL Aggregator (see step 16 of FIG. 13 explained below), via the FL conflict detection and resolution request message. According to example embodiments, the message format is as shown in the table below (“Table 2: FL conflict detection and resolution request message format”).

TABLE 2
FL conflict detection and resolution request message format

| Parameter | Mandatory/Optional | Description |
|---|---|---|
| CNF ID | Mandatory | Which AI pipeline the |
| | | information is provided for. |
| AI QoT Class | Mandatory | Desired AI QoT Class Identifier |
| Identifer | | and/or the fairness, |
| | | explainability & robustness |
| | | requirements for the AI pipeline. |
| Ranking list | Mandatory | Ranked list(s) of candidate |
| of Distributed | | training nodes that satisfy the |
| nodes | | trustworthy requirement criteria. |
| | | The ranking list can also be |
| | | based on individual trustworthy |
| | | requirements, i.e., fairness- |
| | | based ranking, explainability- |
| | | based ranking, robustness-based |
| | | ranking, etc. |
| Selected list | Mandatory | Distributed nodes that have been |
| of distributed | | indicated as selected/blocked for |
| nodes | | a particular (or set of) previous |
| | | iteration(s). |
| Time validity | Mandatory | Time period for which the |
| | | provided information is valid for. |
| Additional | Optional | For example, describing the |
| Information | | criteria used to rank the |
| | | distributed nodes. |

In a step 12 of FIG. 13, according to example embodiments, conflict identification and resolution is performed. Sub-steps of step 12 of FIG. 13 are explained below as steps 12a and 12b.

In a step 12a of FIG. 13, according to example embodiments, based on the received information (from step 11 of FIG. 13), if the FL Coordinator identifies that more than one FL Aggregator(s) are indicating the same (or set of) distributed node(s) as candidate training node(s) for next iteration(s), the distributed node(s) is/are determined to be conflicted. Additionally, if one FL Aggregator has indicated that a particular (or set of) distributed node(s) is selected/blocked and one or more other FL Aggregator(s) indicate the same (or set of) distributed node(s) as candidate training node(s) for next iteration(s), the distributed node(s) (training node(s)) is determined to be conflicted.

In a step 12b of FIG. 13, according to example embodiments, based on the collected information from step 11 of FIG. 13 and based on the conflict identification from step 12a of FIG. 13, the FL Coordinator may decide to allow only the FL Aggregator corresponding to the use case with higher AI QoT requirement to select the conflicted distributed node(s) as the training node, because the FL Aggregator corresponding to the use case with lower AI QoT requirement may not need the distributed node with high TAI capabilities. Alternatively, a customized rule may be defined for conflict resolution based on the information obtained from steps 11 and 12a of FIG. 13.

In a step 13 of FIG. 13, according to example embodiments, the FL Coordinator sends the FL conflict detection and resolution response in the table below (“Table 3: FL conflict detection and resolution response message format”) informing the conflict resolution outcome to each AI Trust Manager (via TFL-2 interface) by sending an updated list of candidate training node list. Then, each AI Trust Manager shall provide the updated distributed node ranking list to the corresponding FL Aggregators.

TABLE 3
FL conflict detection and resolution response message format

| Parameter | Mandatory/Optional | Description |
|---|---|---|
| CNF ID | Mandatory | Which AI pipeline the updated |
| | | training node list is valid for. |
| Updated | Mandatory | Updated ranked list(s) of |
| Ranking list | | candidate training nodes that |
| of Distributed | | satisfy the trustworthy |
| nodes | | requirement criteria after |
| | | conflict detection and resolution. |
| Time validity | Mandatory | Time period for which the |
| | | provided information is valid for. |
| Additional | Optional | For example, describing the |
| Information | | criteria used to detect and |
| | | resolve distributed nodes |
| | | selection conflicts. |

In a step 14 of FIG. 13, the AI Trust Manager(s) may send the distributed node ranking list to the FL aggregator via TFL-1 interface.

In a step 15 of FIG. 13, the FL Aggregator(s) may consider the TAI capabilities (ranking list(s)) of the distributed nodes received in step 14 of FIG. 13 together with other criteria such as resource availability at the distributed nodes, link quality to the distributed nodes, etc., in selecting the distributed nodes that can participate in the next iteration of the FL training process to achieve the use case-specific desired AI QoT and AI QoS.

In a step 16 of FIG. 13, the FL Aggregator(s) may inform about the selected distributed nodes for the next iteration(s) to both AI Trust Manager(s) and AI Pipeline Orchestrator.

In steps 17 to 19 of FIG. 13, the AI Trust Manager(s) may configure, monitor, and measure the AI/ML trustworthy requirements for the selected distributed nodes (via T3, T4 and T5 interfaces as shown in FIG. 10). The measured or collected TAI metrics and/or TAI explanations from the distributed nodes (based on the feedback received in step 16 of FIG. 13) are pushed to the AI Trust Manager over T3, T4 and T5 interfaces. The AI Trust Manager pushes the TAI metrics and/or TAI explanations to the AI Trust Engine, over the T2 interface, based on the reporting mechanisms configured by the AI Trust Engine.

Consequently, according to example embodiments, advantageously, detection and prevention of training node selection conflicts (with respect to their AI/ML trustworthy capabilities) for trustworthy FL when multiple FL aggregators are involved in the training node selection process is provided. This enables e.g. the FL aggregator belonging to a low-risk service to avoid blocking a training node with high trustworthy capabilities, thereby allowing the FL aggregator belonging to a high-risk service to select that training node for FL training.

The above-described procedures and functions may be implemented by respective functional elements, processors, or the like, as described below.

In the foregoing exemplary description of the network entity, only the units that are relevant for understanding the principles of the disclosure have been described using functional blocks. The network entity may comprise further units that are necessary for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, i.e. network entity or node (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

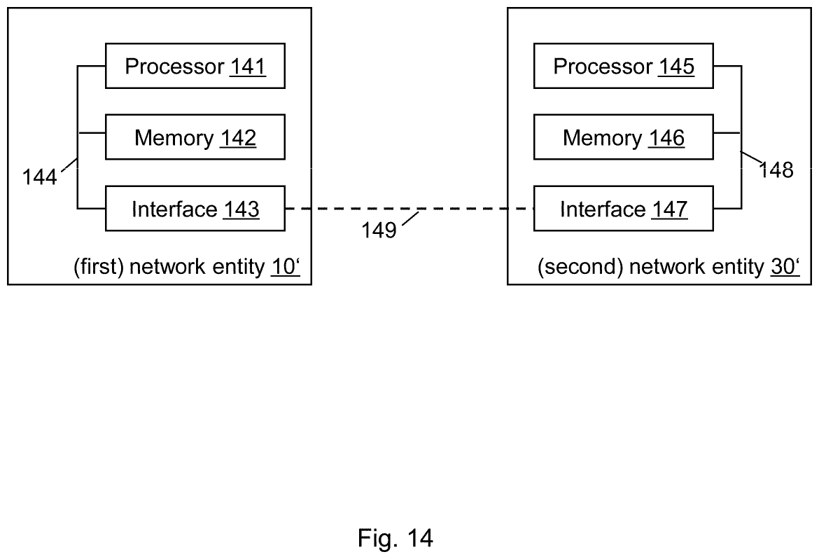

In FIG. 14, an alternative illustration of apparatuses according to example embodiments is depicted. As indicated in FIG. 14, according to example embodiments, the apparatus (network node) 10′ (corresponding to the network node 10) comprises a processor 141, a memory 142 and an interface 143, which are connected by a bus 144 or the like. Further, according to example embodiments, the apparatus (network node) 30′ (corresponding to the network node 30) comprises a processor 145, a memory 146 and an interface 147, which are connected by a bus 148 or the like, and the apparatuses may be connected via link 149, respectively.

The processor 141/145 and/or the interface 143/147 may also include a modem or the like to facilitate communication over a (hardwire or wireless) link, respectively. The interface 143/147 may include a suitable transceiver coupled to one or more antennas or communication means for (hardwire or wireless) communications with the linked or connected device(s), respectively. The interface 143/147 is generally configured to communicate with at least one other apparatus, i.e. the interface thereof.

The memory 142/146 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to example embodiments, an apparatus representing the network node 10 (coordinating artificial intelligence or machine learning contributor selection in a network) comprises at least one processor 141, at least one memory 142 including computer program code, and at least one interface 143 configured for communication with at least another apparatus. The processor (i.e. the at least one processor 141, with the at least one memory 142 and the computer program code) is configured to perform receiving, from a first of a plurality of second network entities managing artificial intelligence or machine learning trustworthiness in artificial intelligence or machine learning pipelines in said network, a first artificial intelligence or machine learning contributor selection conflict resolution request including a first federated learning distributed node candidate list including at least one first federated learning distributed node in said network, wherein each of said at least one first federated learning distributed node has trustworthiness capabilities satisfying first artificial intelligence or machine learning trustworthiness requirement criteria and is associated with a respective rank in said first federated learning distributed node candidate list (thus the apparatus comprising corresponding means for receiving), to perform receiving, from a second of said plurality of second network entities, a second artificial intelligence or machine learning contributor selection conflict resolution request including a second federated learning distributed node candidate list including at least one second federated learning distributed node in said network, wherein each of said at least one second federated learning distributed node has trustworthiness capabilities satisfying second artificial intelligence or machine learning trustworthiness requirement criteria and is associated with a respective rank in said second federated learning distributed node candidate list, to perform transmitting, towards said first of said plurality of second network entities, a first artificial intelligence or machine learning contributor selection conflict resolution response including an updated first federated learning distributed node candidate list removing a conflict between said first federated learning distributed node candidate list and said second federated learning distributed node candidate list (thus the apparatus comprising corresponding means for transmitting), and to perform transmitting, towards said second of said plurality of second network entities, a second artificial intelligence or machine learning contributor selection conflict resolution response including an updated second federated learning distributed node candidate list removing said conflict between said first federated learning distributed node candidate list and said second federated learning distributed node candidate list.

According to example embodiments, an apparatus representing the network node 30 (managing artificial intelligence or machine learning trustworthiness in artificial intelligence or machine learning pipelines in a network) comprises at least one processor 145, at least one memory 146 including computer program code, and at least one interface 147 configured for communication with at least another apparatus. The processor (i.e. the at least one processor 145, with the at least one memory 146 and the computer program code) is configured to perform obtaining a federated learning distributed node candidate list including at least one federated learning distributed node in said network, wherein each of said at least one federated learning distributed node has trustworthiness capabilities satisfying artificial intelligence or machine learning trustworthiness requirement criteria and is associated with a respective rank in said federated learning distributed node candidate list (thus the apparatus comprising corresponding means for obtaining), and to perform transmitting, towards a first network entity coordinating artificial intelligence or machine learning contributor selection in said network, an artificial intelligence or machine learning contributor selection conflict resolution request including said federated learning distributed node candidate list (thus the apparatus comprising corresponding means for transmitting).

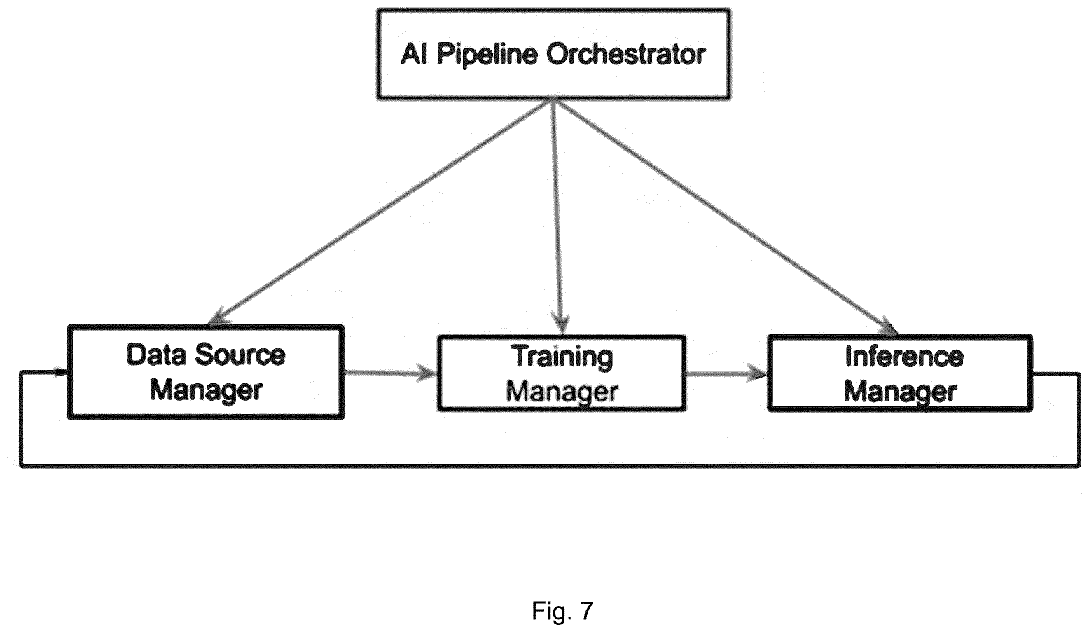

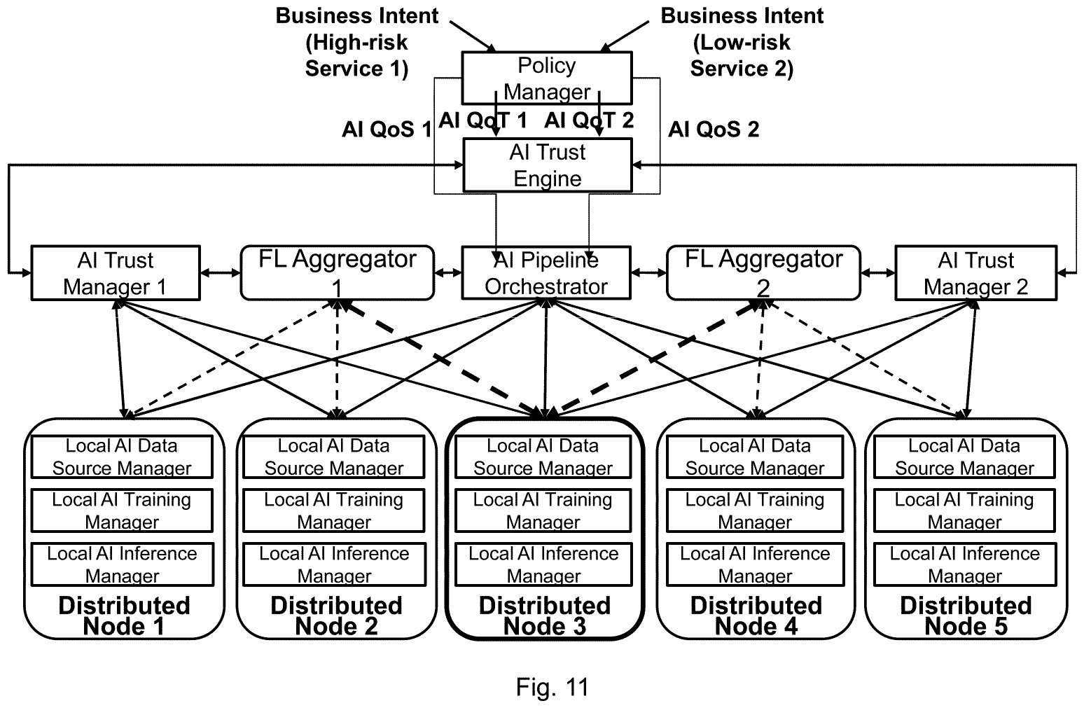

For further details regarding the operability/functionality of the individual apparatuses, reference is made to the above description in connection with any one of FIGS. 1 to 13, respectively.

For the purpose of the present disclosure as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for enhancement of training node selection for trustworthy federated learning. Such measures exemplarily comprise, at a first network entity coordinating artificial intelligence or machine learning contributor selection in a network, receiving, respectively from a first and a second of a plurality of second network entities managing artificial intelligence or machine learning trustworthiness in artificial intelligence or machine learning pipelines in said network, a first/second artificial intelligence or machine learning contributor selection conflict resolution request including a first/second federated learning distributed node candidate list including at least one first/second federated learning distributed node in said network, wherein each of said at least one first/second federated learning distributed node has trustworthiness capabilities satisfying first/second artificial intelligence or machine learning trustworthiness requirement criteria and is associated with a respective rank in said first/second federated learning distributed node candidate list, transmitting, respectively towards said first and said second of said plurality of second network entities, a first/second artificial intelligence or machine learning contributor selection conflict resolution response including an updated first/second federated learning distributed node candidate list removing a conflict between said first federated learning distributed node candidate list and said second federated learning distributed node candidate list.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

### LIST OF ACRONYMS AND ABBREVIATIONS

3GPP Third Generation Partnership Project
AI artificial intelligence
AI QOT AI quality of trustworthiness
CAN cognitive autonomous network
CNF cognitive network function
FL federated learning
FLA federated learning aggregator
HLEG High-level Expert Group
IEC International Electrotechnical Commission
ISO International Organization for Standardization
MANO Management and Orchestration
ML machine learning
QCI QoS class identifier
Qos quality of service
QOT quality of trustworthiness
TAI trustworthy AI
TAIF trustworthy artificial intelligence framework
TED Teaching Explainable Decisions
TFL trustworthy federated learning
VNF virtual network function

1-56. (canceled)

57. A method of a first network entity coordinating artificial intelligence or machine learning contributor selection in a network, the method comprising
receiving, from a first of a plurality of second network entities managing artificial intelligence or machine learning trustworthiness in artificial intelligence or machine learning pipelines in said network, a first artificial intelligence or machine learning contributor selection conflict resolution request including a first federated learning distributed node candidate list including at least one first federated learning distributed node in said network, wherein each of said at least one first federated learning distributed node has trustworthiness capabilities satisfying first artificial intelligence or machine learning trustworthiness requirement criteria and is associated with a respective rank in said first federated learning distributed node candidate list,
receiving, from a second of said plurality of second network entities, a second artificial intelligence or machine learning contributor selection conflict resolution request including a second federated learning distributed node candidate list including at least one second federated learning distributed node in said network, wherein each of said at least one second federated learning distributed node has trustworthiness capabilities satisfying second artificial intelligence or machine learning trustworthiness requirement criteria and is associated with a respective rank in said second federated learning distributed node candidate list,
transmitting, towards said first of said plurality of second network entities, a first artificial intelligence or machine learning contributor selection conflict resolution response including an updated first federated learning distributed node candidate list removing a conflict between said first federated learning distributed node candidate list and said second federated learning distributed node candidate list, and
transmitting, towards said second of said plurality of second network entities, a second artificial intelligence or machine learning contributor selection conflict resolution response including an updated second federated learning distributed node candidate list removing said conflict between said first federated learning distributed node candidate list and said second federated learning distributed node candidate list.

58. The method according to claim 57, further comprising
analyzing said first federated learning distributed node candidate list and said second federated learning distributed node candidate list,
determining, based on a result of said analyzing, whether a federated learning distributed node is present in said first federated learning distributed node candidate list and in said second federated learning distributed node candidate list, and
if said federated learning distributed node is present in said first federated learning distributed node candidate list and in said second federated learning distributed node candidate list,
setting said federated learning distributed node present in said first federated learning distributed node candidate list and in said second federated learning distributed node candidate list as at least one conflicting federated learning distributed node.

59. The method according to claim 58, wherein
said first artificial intelligence or machine learning contributor selection conflict resolution request further includes information on said first artificial intelligence or machine learning trustworthiness requirement criteria, and/or
said second artificial intelligence or machine learning contributor selection conflict resolution request further includes information on said second artificial intelligence or machine learning trustworthiness requirement criteria.

60. The method according to claim 58, wherein
said first artificial intelligence or machine learning contributor selection conflict resolution request further includes information on at least one previously selected first federated learning distributed node previously selected for artificial intelligence or machine learning contribution, and/or
said second artificial intelligence or machine learning contributor selection conflict resolution request further includes information on at least one previously selected second federated learning distributed node previously selected for artificial intelligence or machine learning contribution.

61. The method according to claim 60, further comprising
determining, based on a result of said analyzing, whether a federated learning distributed node is present in said first federated learning distributed node candidate list and in said at least one previously selected second federated learning distributed node, and
if said federated learning distributed node is present in said first federated learning distributed node candidate list and in said at least one previously selected second federated learning distributed node,
setting said federated learning distributed node present in said first federated learning distributed node candidate list and in said at least one previously selected second federated learning distributed node as said at least one conflicting federated learning distributed node, and
determining, based on a result of said analyzing, whether a federated learning distributed node is present in said second federated learning distributed node candidate list and in said at least one previously selected first federated learning distributed node, and
if said federated learning distributed node is present in said second federated learning distributed node candidate list and in said at least one previously selected first federated learning distributed node,
setting said federated learning distributed node present in said second federated learning distributed node candidate list and in said at least one previously selected first federated learning distributed node as said at least one conflicting federated learning distributed node.

62. The method according to claim 58, further comprising
updating, based on information included in said first artificial intelligence or machine learning contributor selection conflict resolution request and information included in said second artificial intelligence or machine learning contributor selection conflict resolution request, said first federated learning distributed node candidate list to generate said updated first federated learning distributed node candidate list and said second federated learning distributed node candidate list to generate said updated second federated learning distributed node candidate list.

63. The method according to claim 62, wherein
in relation to said updating, the method further comprises
removing, based on said information included in said first artificial intelligence or machine learning contributor selection conflict resolution request and said information included in said second artificial intelligence or machine learning contributor selection conflict resolution request, said at least one conflicting federated learning distributed node either from said first federated learning distributed node candidate list or from said second federated learning distributed node candidate list.

64. The method according to claim 63, wherein
in relation to said updating, the method further comprises
removing said at least one conflicting federated learning distributed node from said first federated learning distributed node candidate list, if said second artificial intelligence or machine learning trustworthiness requirement criteria are higher than said first artificial intelligence or machine learning trustworthiness requirement criteria, and
removing said at least one conflicting federated learning distributed node from said second federated learning distributed node candidate list, if said first artificial intelligence or machine learning trustworthiness requirement criteria are higher than said second artificial intelligence or machine learning trustworthiness requirement criteria.

65. The method according to claim 62, wherein
in relation to said updating, the method further comprises
marking, based on said information included in said first artificial intelligence or machine learning contributor selection conflict resolution request and said information included in said second artificial intelligence or machine learning contributor selection conflict resolution request, said at least one conflicting federated learning distributed node either in said first federated learning distributed node candidate list or in said second federated learning distributed node candidate list as inhibited.

66. The method according to claim 65, wherein
in relation to said updating, the method further comprises
marking said at least one conflicting federated learning distributed node in said first federated learning distributed node candidate list as inhibited, if said second artificial intelligence or machine learning trustworthiness requirement criteria are higher than said first artificial intelligence or machine learning trustworthiness requirement criteria, and
marking said at least one conflicting federated learning distributed node in said second federated learning distributed node candidate list as inhibited, if said first artificial intelligence or machine learning trustworthiness requirement criteria are higher than said second artificial intelligence or machine learning trustworthiness requirement criteria.

67. The method according to claim 57, further comprising
receiving, from said first of said plurality of second network entities, a first artificial intelligence or machine learning contributor selection conflict resolution registration message,
registering said first of said plurality of second network entities for artificial intelligence or machine learning contributor selection conflict resolution,
receiving, from said second of said plurality of second network entities, a second artificial intelligence or machine learning contributor selection conflict resolution registration message, and
registering said second of said plurality of second network entities for artificial intelligence or machine learning contributor selection conflict resolution.

68. A method of a second network entity managing artificial intelligence or machine learning trustworthiness in artificial intelligence or machine learning pipelines in a network, the method comprising
obtaining a federated learning distributed node candidate list including at least one federated learning distributed node in said network, wherein each of said at least one federated learning distributed node has trustworthiness capabilities satisfying artificial intelligence or machine learning trustworthiness requirement criteria and is associated with a respective rank in said federated learning distributed node candidate list, and
transmitting, towards a first network entity coordinating artificial intelligence or machine learning contributor selection in said network, an artificial intelligence or machine learning contributor selection conflict resolution request including said federated learning distributed node candidate list.

69. The method according to claim 68, wherein
said artificial intelligence or machine learning contributor selection conflict resolution request further includes information on said artificial intelligence or machine learning trustworthiness requirement criteria.

70. The method according to claim 68, wherein
said artificial intelligence or machine learning contributor selection conflict resolution request further includes information on at least one previously selected federated learning distributed node previously selected for artificial intelligence or machine learning contribution.

71. The method according to claim 68, further comprising
receiving, from said first network entity, an artificial intelligence or machine learning contributor selection conflict resolution response including an updated federated learning distributed node candidate list, and
transmitting, towards a third network entity implementing a federated learning central node in said network, said updated federated learning distributed node candidate list.

72. The method according to claim 71, wherein
in said updated federated learning distributed node candidate list, a conflicting federated learning distributed node of said at least one federated learning distributed node in said federated learning distributed node candidate list is removed.

73. The method according to claim 71, wherein
in said updated federated learning distributed node candidate list, a conflicting federated learning distributed node of said at least one federated learning distributed node in said federated learning distributed node candidate list is marked as inhibited.

74. The method according to claim 73, further comprising
modifying said updated federated learning distributed node candidate list to indicate that said conflicting federated learning distributed node has insufficient trustworthiness capabilities.
